(19) United States
(12) Patent Application Publication
(10) Pub. No.: US 2026/0265941 A1
(43) Pub. Date: Sep. 10, 2026

(54) WATER PURIFICATION FOR ELECTROCHEMICAL SYSTEMS AND ASSOCIATED METHODS

(71) Applicant: HYAXIOM, INC, East Hartford, CT (US)

(72) Inventors: Sean Foley, Windsor Locks, CT (US); Cameron Armstrong, Manchester, CT (US)

(21) Appl. No.: 19/069,933

(22) Filed: Mar. 4, 2025

(51) Int. Cl. C25B 15/08; B01D 15/18; B01D 15/36; C25B 1/04; C25B 15/021

(52) U.S. Cl. CPC C25B 15/085; B01D 15/1871; B01D 15/1885; B01D 15/361; C25B 1/04; C25B 15/021; C25B 15/087

(57) ABSTRACT

A system may include an electrochemical cell assembly having an anode inlet and an anode outlet. The system may include a tank configured to hold a volume of water and a supply line interconnecting the storage tank and the anode inlet. The system may include a return line interconnecting the storage tank and the anode outlet. The system may include an ion exchange assembly including an exchange inlet and an exchange outlet and a heat exchanger interconnecting the storage tank and the exchange inlet. The system may include an economizer configured to transfer heat energy of water flowing through a first channel to water flowing through a second channel of the economizer, the first channel interconnecting the storage tank and an inlet of the heat exchanger, and the second channel configured to receive a flow of water from the exchange outlet. A method for treating water for electrolysis is also disclosed.

### BACKGROUND

This disclosure relates to systems and methods for water purification and waste heat utilization for electrochemical systems.

An electrochemical system may include an electrolyzer that uses electricity to split water into hydrogen and oxygen. One example of an electrochemical assembly is a Polymer Electrolyte Membrane (PEM) electrolyzer, which may include a membrane electrode assembly (MEA) having an anode on one side and a cathode on the other side. Water purity may ensure optimal performance and longevity of the PEM electrolyzer. Impurities such as dissolved ions, organic compounds, and particulates can degrade the membrane, poison catalysts, and reduce overall efficiency. To prevent contamination and maintain efficiency, the water may be purified before being fed to the PEM electrolyzer.

Purification methods may include communicating water through ion exchange resin filters, which remove unwanted ions, thereby reducing conductivity and preventing scale formation. One technique includes electro-deionization (EDI), which is a chemical-free water purification process that removes dissolved ions from water using electricity. Additionally, reverse osmosis (RO) systems utilize semipermeable membranes to filter out dissolved solids, bacteria, and organic contaminants. A combination of these methods may be employed to achieve purified water for stable and efficient electrolyzer operation.

### SUMMARY

This disclosure relates to water purification systems and methods for an electrochemical assembly. The systems and methods may be used to purify water in a purification path for use in the electrochemical assembly. A heat exchanger may be situated in the purification path.

A system for electrolysis may include an electrochemical cell assembly having an anode inlet and an anode outlet. A tank is configured to hold a volume of water and is provided. A supply line interconnects the tank and the anode inlet and a return line interconnects the tank and the anode outlet. An ion exchange assembly includes an exchange inlet and an exchange outlet and a heat exchanger interconnects the tank and the exchange inlet. An economizer may be configured to transfer heat energy of water flowing through a first channel to water flowing through a second channel of the economizer. The first channel interconnects the tank and an inlet of the heat exchanger, and the second channel configured to receive a flow of water from the exchange outlet. An ion exchange assembly includes a plurality of ion exchange filters arranged in first and second flow paths. A third flow path of the ion exchange assembly may be configured to selectively bypass the first and second flow paths. A controller is operable to modulate one or more of valves and/or one or more pumps to vary a flow rate and/or a temperature of water flowing among the electrochemical cell assembly, storage tank, heat exchanger, ion exchange assembly, and economizer.

A method for treating water for electrolysis includes communicating water from an anode outlet of an electrochemical cell assembly via a return line to a tank. Water is communicated from the tank to a first channel of an economizer via a feed line. Water is communicated from the first channel of the economizer to a heat exchanger to remove heat energy from the water. Water is communicated from the heat exchanger to an ion exchange assembly to remove impurities in the water. Purified water is communicated from the ion exchange assembly to a second channel of the economizer to transfer heat energy from water in the first channel to the purified water in the second channel. Purified water is communicated from the second channel of the economizer to an anode inlet of the electrochemical cell assembly. Supply water is communicated from the tank to the anode inlet via a supply line such that the water bypasses the ion exchange assembly.

The present disclosure may include any one or more of the individual features disclosed above and/or below alone or in any combination thereof.

Various features and advantages of at least one disclosed example embodiment will become apparent to those skilled in the art from the following detailed description. The drawings that accompany the detailed description can be briefly described as follows.

### BRIEF DESCRIPTION OF THE DRAWING

FIG. 1 schematically illustrates a selected portion of an electrochemical assembly according to an implementation.

FIG. 2 is a schematic representation of a water temperature control system for an electrochemical assembly according to an implementation.

FIG. 3 is a schematic representation of a water temperature control system for an electrochemical assembly according to another implementation.

### DETAILED DESCRIPTION

The systems and methods disclosed herein may be useful for purifying water in a purification path and conveying the purified water to an electrochemical assembly.

A system for electrolysis according to an implementation may include an electrochemical cell assembly having an anode inlet and an anode outlet. A storage tank may be configured to hold a volume of water. A supply line may interconnect the storage tank and the anode inlet. A return line may interconnect the storage tank and the anode outlet. An ion exchange assembly may include an exchange inlet and an exchange outlet. A heat exchanger may interconnect the storage tank and the exchange inlet. An economizer may be configured to transfer heat energy of water flowing through a first channel to water flowing through a second channel of the economizer. The first channel may interconnect the storage tank and an inlet of the heat exchanger. The second channel may be configured to receive a flow of water from the exchange outlet.

In any implementations, the tank may include a tank inlet connected to the anode outlet via the return line. The first tank outlet may be connected to the inlet of the economizer via a feed line. The second tank outlet may be connected to the anode inlet via the supply line.

In any implementations, a purification line may interconnect an outlet of the second channel of the economizer and a junction along the supply line.

In any implementations, a purification line may interconnect an outlet of the second channel of the economizer and a second tank inlet of the storage tank.

In any implementations, the ion exchange assembly may include a plurality of ion exchange resin filters arranged in a plurality of flow paths between the exchange inlet and the exchange outlet.

In any implementations, the plurality of flow paths may include first and second flow paths, and the plurality of ion exchange resin filters may include first and second ion exchange resin filters arranged in series in the first flow path and third and fourth ion exchange resin filters arranged in series in a second flow path. The first and second flow path may be arranged in parallel.

In any implementations, the plurality of flow paths may include a third flow path arranged in parallel with the first and second flow paths. The third flow path may be a bypass line interconnecting the exchange inlet and the exchange outlet that may be configured to selectively bypass the first and second flow paths.

In any implementations, a junction along the supply line may be adapted to combine a first flow from the supply tank and a second flow from an outlet of the second channel. The supply line may be adapted to communicate the combined flow to the anode inlet. The second flow may establish approximately at least 10 percent of the combined flow.

In any implementations, a controller may be operable to modulate one or more valves and/or one or more pumps to vary a flow rate and/or a temperature of water flowing among the electrochemical cell assembly, storage tank, heat exchanger, ion exchange assembly, and/or economizer.

In any implementations, the controller may be operable to maintain a temperature of water at the anode inlet between approximately 60° C. and 80° C.

In any implementations, the controller may be configured to maintain a temperature of water at the exchange inlet below approximately 60° C.

A method for treating water for electrolysis according to an implementation may include communicating water from an anode outlet of an electrochemical cell assembly via a return line to a storage tank. The method may include communicating water from the storage tank to a first channel of an economizer via a feed line. The method may include communicating water from the first channel of the economizer to a heat exchanger to remove heat energy from the water. The method may include communicating water from the heat exchanger to an ion exchange assembly to remove impurities in the water. The method may include communicating purified water from the ion exchange assembly to a second channel of the economizer to transfer heat energy from water in the first channel to the purified water in the second channel. The method may include communicating purified water from the second channel of the economizer to an anode inlet of the electrochemical cell assembly. The method may include communicating purified water from the storage tank to the anode inlet via a supply line such that the water bypasses the ion exchange assembly.

In any implementations, the method may include feeding purified water from the second channel of the economizer to the storage tank through a second tank inlet via a purification line, such that the purified water and supply water may combine in the storage tank to establish a combined flow which is communicated from the storage tank to the anode inlet via the supply line.

In any implementations, the method may include feeding purified water from the second channel of the economizer to a junction along the supply line via a purification line such that the purified water and supply water may combine to establish a combined flow to the anode inlet.

In any implementations, the purified water may be at least approximately 10 percent of the combined flow to the anode inlet but may be no more than approximately 70 percent of the combined flow to the anode inlet.

In any implementations, the ion exchange assembly may include a plurality of ion exchange resin filters arranged in a plurality of flow paths between an exchange inlet and an exchange outlet.

In any implementations, the plurality of ion exchange resin filters may include first and second ion exchange resin filters that may be arranged in series in a first flow path and/or third and fourth ion exchange resin filters that may be arranged in series in a second flow path. The first and second flow path may be arranged in parallel.

In any implementations, the ion exchange assembly may include a third flow path arranged in parallel with the first and second flow path. The third flow path may be configured to cause water to selectively bypass the first and second flow paths.

In any implementations, the method may include maintaining a temperature of water at the anode inlet to be between approximately 60° C. and 80° C.

In any implementations, the method may include maintaining a temperature of water at the exchange inlet to be less than approximately 60° C.

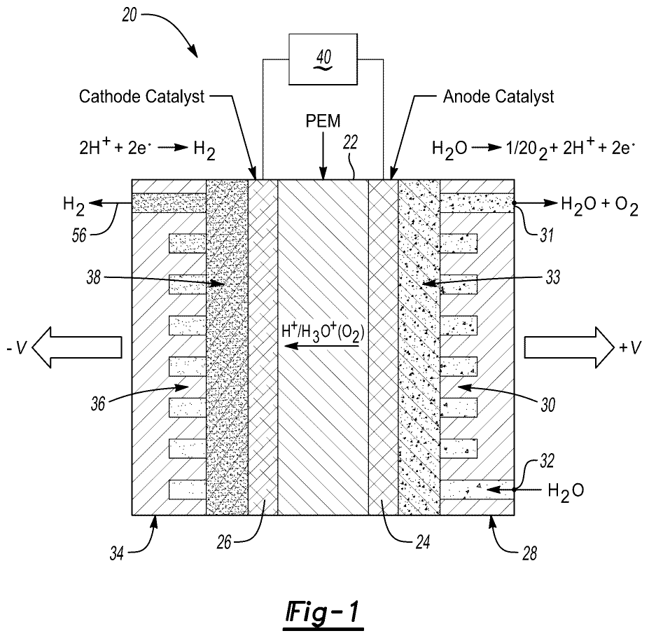

FIG. 1 discloses an electrochemical cell assembly (e.g., device) 20. The assembly 20 may include a single cell or may include a plurality of cells arranged to establish a stack. The cells may be interconnected by one or more manifolds. The electrochemical assembly 20 may be an electrolyzer such as a polymer electrolyte membrane water electrolyzer (PEMWE). Operation of electrolyzers is known. Other electrochemical devices may benefit from the teachings disclosed herein, such as fuel cells.

The assembly 20 may include a polymer electrolyte membrane (PEM) 22 situated between an anode catalyst layer 24 and a cathode catalyst layer 26. An anode portion 28 may include an anode flowfield component 30 having an anode inlet 31 and an anode outlet 32. The anode portion 28 may further include an anode transport layer 33. A cathode portion 34 may include a cathode flowfield component 36 and a cathode transport layer 38. FIG. 1 shows a diffusion of H2O and O2 from the anode 28 to the cathode 34. A power source 40 may be adapted to supply current to facilitate an electrolysis reaction for producing hydrogen and oxygen. At the anode catalyst layer 24 water molecules may split into oxygen gas (O₂₎, protons (H⁺), and electrons (e⁻). The PEM 22 may be adapted to only allow protons (H⁺) to pass through to the cathode 34 while the oxygen gas along with unreacted water may be released as a byproduct from the anode portion 28. At the cathode catalyst layer 26 the protons (H⁺) may combine with electrons (e⁻) from an external electrical circuit to form hydrogen gas (H₂). The hydrogen gas (H₂) may then be directed from the electrochemical assembly 20.

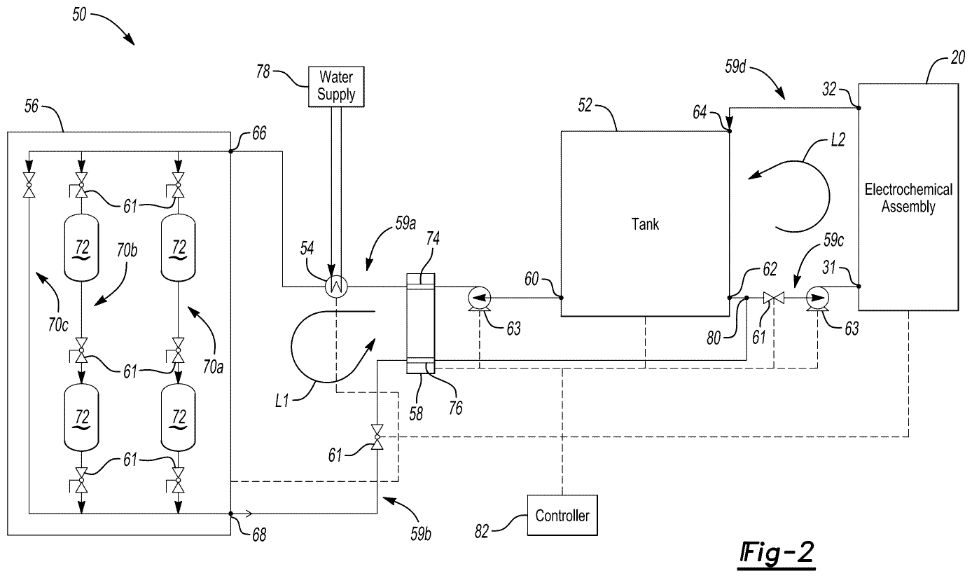

FIG. 2 discloses an electrochemical system 50 according to an implementation. The system 50 may include features for utilizing waste heat and controlling the temperature of water used for electrolysis. The electrochemical system 20 of FIG. 1 is one implementation of an electrochemical system that may be incorporated into the system 50 of FIG. 2. Other electrolyzers, such as solid oxide electrolyzers or those utilizing anion exchange membranes, may also perform electrolysis within the system 50.

The system 50 may include a storage (e.g., water) tank 52 adapted to hold a volume of water, a heat exchanger 54, a purification (e.g., ion exchange) assembly 56, and/or an economizer 58 that may be interconnected by one or more circulation lines (e.g., conduits) 59 (e.g., 59a-59d). One or more valves 61 and/or pumps 63 may be situated along the lines 59 to modulate water flow from the tank 52 through the rest of the system 50. The pumps 63 and valves 61 shown in FIG. 2 are exemplary and additional or fewer valves 61 and pumps 63 may be positioned at different locations along the water lines 59. The tank 52 may be adapted to supply water to the system 50 through first and second tank outlets 60, 62. Water may be returned to the tank 52 from the assembly 20 through a tank inlet 64. The tank 52 may include other configurations. In an implementation, the first and second tank outlets 60, 62 may be combined into a single outlet with separate water lines directing the water therefrom.

The ion exchange assembly 56 may include an exchange inlet 66 and an exchange outlet 68. One or more flow paths 70 may be established between the exchange inlet 66 and exchange outlet 68. In implementations, the flow paths 70 may include first, second, and third flow paths 70a-c arranged in parallel between the exchange inlet 66 and exchange outlet 68. The flow paths 70a-c may be configured as separate lines 59. Each of the first and second flow paths 70a, 70b may include one or more (e.g., ion resin) filters 72. The first and second flow paths 70a, 70b may include sets of ion resin filters 72 positioned along the respective paths. The ion resin filters 72 may be arranged in series in the respective flow paths 70a, 70b. The third flow path 70c may be configured as a bypass line that may be adapted to selectively route water through the ion exchange assembly 56, bypassing the first and second flow paths 70a, 70b. The third flow path 70c may not include ion resin filters; any water flowing through the third flow path 70c may not undergo a (e.g., ion exchange) filtration process. In implementations, the third flow path 70c may be omitted. The ion exchange assembly 56 may be adapted to include fewer or more flow paths 70 incorporating one or more respective filters 72. Incorporating at least two separate flow paths 70 with filter(s) 72 may facilitate servicing (e.g., replacing) the filter(s) 72 in one of the flow paths 70 without interrupting operation of the system 20 including providing purification with the filter(s) 72 in the other flow path(s) 70. The ion exchange assembly 56 may not necessarily be a physical housing or structure but may be a general designation for a portion of the system 50 that includes the flow paths 70 and ion exchange resin filters 72. The exchange inlet 66 and exchange outlet 68 do not have to be physical inlets and outlets distinct from the water lines 59 but instead may serve as general designations of the ion exchange assembly 56 boundary within the system 50.

The ion resin filters 72 may incorporate synthetic, porous, polymer-based materials that may be suitable for removing unwanted ions from the water flowing through the ion exchange assembly 56 and replacing them with desirable ions. These resin materials may be small, bead-like structures with functional groups that may attract and exchange specific ions. Various resin materials may be utilized such as cation exchange resins, anion exchange resins, or mixed-bed resins. Cation exchange resins remove positively charged ions, such as calcium, magnesium, and sodium, replacing them with hydrogen or other desired cations. Anion exchange resins remove negatively charged ions, such as chloride, sulfate, and nitrate, replacing them with hydroxide or other desired anions. Mixed-bed resins contain both cation and anion exchange resins, providing high-purity filtration and are often used in ultrapure water systems.

The resin filters 72 may be adapted to remove impurities from water circulated through the system 50 from the tank 52. Impurities such as calcium, magnesium, and chloride ions may lead to scaling, membrane fouling, and/or corrosion of the electrodes and other components of the electrochemical assembly 20, thereby reducing efficiency and lifespan of the assembly 20. Feeding water through the ion exchange resin filters 72 before it enters the electrochemical assembly 20 may eliminate or otherwise reduce impurities that may negatively affect the electrolysis process and the longevity of components of the electrochemical assembly 20. The high-purity water obtained from the ion resin filtering process may ensure consistent electrochemical reactions and may minimize or otherwise reduce unwanted side reactions and could affect hydrogen production efficiency.

The system 50 may include a first (e.g., purification) loop (e.g., path) L1 and a second (e.g., circulation) loop (e.g., path) L2, which may provide alternative routes for water to flow between the tank 52 and electrochemical assembly 20. The first loop L1 may include a feed line 59a, the flow paths 70 through the ion exchange assembly 56, and/or a purification line 59b. The first loop L1 may be adapted to communicate water from the tank 52 to the ion exchange assembly 56 for purification before the water is directed to the electrochemical assembly 20. Components of the system 50 situated within the first loop L1 may include the tank 52, economizer 58, heat exchanger 54, and/or ion exchange assembly 56. The second loop L2 may include a supply line 59c and a return line 59d. The second loop L2 may be adapted to bypass the ion exchange assembly 56 and may be adapted to communicate water directly between the tank 52 and electrochemical assembly 20. Components of the system 50 situated within the second loop L2 may include the tank 52 and electrochemical assembly 20. In implementations, the first loop L1 may converge with the second loop L2 at a junction 80. Water flowing through the first loop L1 may enter the second loop L2. The first loop L1 may include a portion of the second loop L2.

The economizer 58 may include a heat exchanger. Various heat exchangers may be utilized, such as a plate heat exchanger, shell-and-tube exchanger, double-pipe heat exchanger, and/or spiral heat exchanger. The economizer 58 may include a first (e.g., supply) channel 74 and a second (e.g., return) channel 76. The channels 74, 76 may be adapted to direct separate and distinct flow of water through the economizer 58 while transferring heat energy therebetween.

The first channel 74 of the economizer 58 may have an inlet and an outlet adapted to interconnect respective segments of the feed line 59a. The feed line 59a may be connected to the first tank outlet 60 at one end and may be connected to the exchange inlet 66 at the other end. Water in the feed line 59a may flow in a direction from the tank 52 towards the ion exchange assembly 56 along the feed line 59a. The feed line 59a may communicate water from the tank 52 to the first channel 74 of the economizer 58, from the first channel 74 of the economizer 58 to the heat exchanger 54, and from the heat exchanger 54 to the exchange inlet 66. The heat exchanger 58 may be adapted to receive a flow of relatively cold water from a water supply 78 and may remove heat energy from the relatively warmer water flowing through the feed line 59a.

The second channel 76 of the economizer 58 may have an inlet and outlet adapted to interconnect respective segments of the purification line 59b. The purification line 59b may be connected to the exchange outlet 68 at one end and may be connected to the supply line 59c at the junction 80 at the other end. Other configurations for directing the flow of water from the purification line 59b to the electrochemical assembly 20 may be utilized. In implementations, the purification line 59b may be connected directly to the electrochemical assembly 20 (e.g., at a manifold) and the junction 80 may be eliminated. The junction 80 may be configured as a three-way valve or other mechanism to control the flow of water from the purification line 59b to the supply line 59c. Water in the purification line 59b may flow in a direction from the exchange outlet 68 towards the junction 80. The purification line 59b may communicate water from the exchange outlet 68 to the second channel 76 of the economizer 58, and from the second channel 76 of the economizer 58 to the junction 80. Incorporating the junction 80 may provide a more purified flow of water to the electrochemical device 20 than if the flow were sourced entirely from the tank 52.

The supply line 59c may be connected to the second outlet 62 of the tank 52 at one end and may be connected to a first (e.g., anode) inlet 31 of the assembly 20 at the other end. The junction 80 may be adapted to join two separate flows of water—one from the tank 52 and another from the economizer 58 through the purification line 59b—into a single, combined flow of water for processing by the assembly 20 through the anode inlet 31. The combined flow of water may pass through the assembly 20, between the anode inlet 31 and a first (e.g., anode) outlet 32, with some of the water being used in the electrolysis process. The anode inlet 31 and/or anode outlet 32 may be manifolds adapted to control a flow of water in the assembly 20. The return line 59d may be connected to the anode outlet 32 of the assembly 20 at one end and may be connected to the tank inlet 64 at the other end. Water that does not undergo the electrolysis process within the assembly 20 may be communicated via the return line 59d from the assembly 20 back to the tank 52. Water within the tank 52 may be stored until it is circulated through the system 50.

Operating temperatures for efficient performance of the ion resin filters 72 and the assembly 20 may differ due to their distinct functions and the materials involved in each process. The ion resin filters 72 may be adapted to operate at temperatures between approximately 15° C. and 60° C. Operating outside this temperature range may affect the mechanical integrity of the resin beads. A chemistry of the resin beds may also be affected if water flowing into the ion resin filters 72 exceeds 60° C., which may impact the effective lifetime of the resin before replacement and/or regeneration is planned (e.g., required). The assembly 20 may be adapted to operate at temperatures greater than or equal to approximately 60° C., such as between approximately 60° C. and approximately 80° C. At these higher temperatures, the assembly 20 processes may be more efficient, as higher temperatures may reduce the electrical energy required to split the water molecules. The techniques disclosed herein may be utilized to cool and reheat the water as necessary within the system 50, depending on whether the water is flows to the ion resin filters 72 or the assembly 20. For the purpose of this disclosure, the term “approximately” means ±10 percent of the stated value or relationship unless otherwise indicated.

The economizer 58 may be positioned within the system 50 based on a difference in temperature of water flowing through the feed line 59a and purification line 59b and may utilize the heat energy of water flowing through the feed line 59a before rejecting it from the system 50 at the heat exchanger 54. The heat exchanger 54 may be situated along the feed line 59a at a position between the ion exchange assembly 56 and the first channel 74 of the economizer 58. The second channel 76 of the economizer 58 may be situated along the purification line 59b between the electrochemical assembly 20 and the ion exchange assembly 56. The economizer 58 may be adapted to transfer heat energy from water flowing through the first channel 74 (e.g., before much of the heat energy is removed by the heat exchanger 54) to water flowing through the second channel 76.

The system 50 may include a controller 82 operable to monitor and/or control various components of the system 50 such as the valves 61 and/or pumps 63. The controller 82 may be operable to modulate flow from the water supply 78 to set a temperature of water flow in the heat exchanger 54. A system of controllers 82 may be employed, with each controller 82 assigned to specific components of the system 50. These controllers 82 may be operable to communicate with one another over a network or other communication method. The controller 82 may include a memory unit for storing data related to the system 50 performance, operational history, and/or user-defined parameters, and one or more processors operable to collectively control the system 50 based on the stored data and/or real-time inputs. The processor may include a microprocessor, microcontroller, or any other suitable processing hardware. The controller 82 may be equipped with a communication interface for remote monitoring and control. The controller 82 may be operable to monitor and/or set (e.g., vary) the flow rate and/or temperature of water flowing through various parts of the system 50, such as the heat exchanger 54, economizer 58, ion exchange resin filters 72, tank 52, and/or assembly 20 to maintain water flow within a (e.g., preselected) range for each process. In response to a detected temperature change, the controller 82 may be operable to adjust the flow rates through the line(s) 59 and/or flow path(s) 70. The controller 82 may be operable to set (e.g., regulate) flow rates and/or temperature of water through the different line(s) 59 and/or flow path(s) 70 by modulating the one or more valves 61 and/or one or more pumps 63, which may ensure the proper distribution of water. The controller 82 may be operable to modulate the valve(s) 61 and/or pump(s) 63 based on water quality, which may be determined by various techniques such as conductivity measurements and/or ion concentration analysis. In implementations, at least approximately 10 percent or more of the combined flow into the assembly 20 may be supplied from the purification line 59b, while a remainder of the combined flow may be supplied from the second tank outlet 62. In implementations, no more than approximately 70 percent of the combined flow into the assembly 20 may be supplied from the purification line 59b, while a remainder of the combined flow may be supplied from the second tank outlet 62.

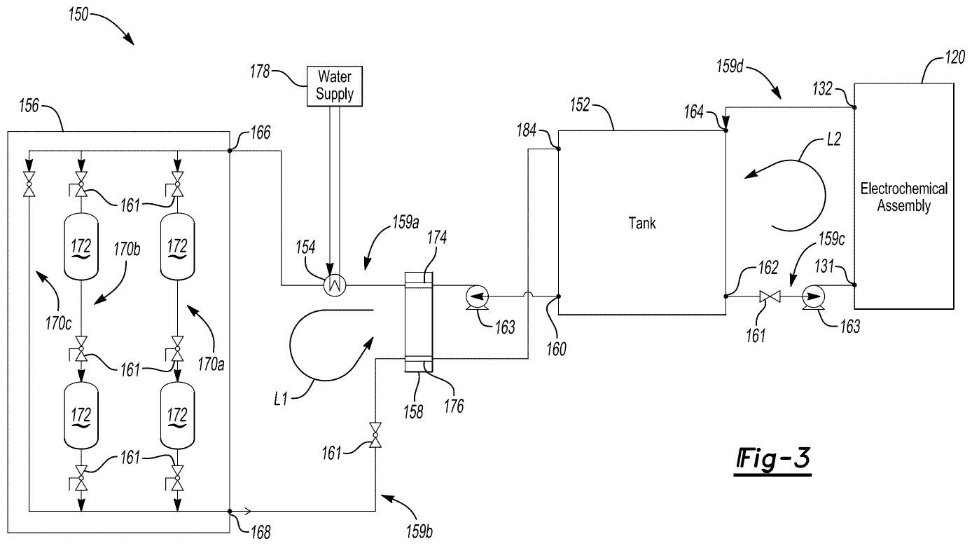

FIG. 3 discloses a system 150 according to another implementation. In this disclosure, like reference numerals designate like elements where appropriate and reference numerals with the addition of one-hundred or multiples thereof designate modified elements that are understood to incorporate the same features and benefits of the corresponding original elements. The system 150 may incorporate the controller 82 (FIG. 2). In this implementation, a first loop L1 and a second loop L2 may not converge at a junction along a supply line 159c. A tank 152 may include a second tank inlet 184 adapted to receive a flow of water from the first loop L1. Water flowing through a purification line 159b may be directed to the tank 152 after flowing through a second channel 176 of an economizer 158. The purification line 159b may interconnect an exchange outlet 168 and the second tank inlet 184. Purified water flowing into the tank 152 through the second tank inlet 184 may be combined in the tank 152 with return water flowing into the tank 152 through the first tank inlet 164. A portion of the combined water in the tank 152 may be directed to the ion exchange assembly 156 through the first tank outlet 160 or may be directed to the assembly 120 through the second tank outlet 162.

A method for treating (e.g., purifying) water for electrolysis may include any of the techniques disclosed herein. The method may be applied to the systems 50, 150. Reference is made to the system 50. The method may include communicating water from the first outlet 32 of the assembly 20 via the return line 59d to the tank 52. Water may be communicated from the tank 52 to the first channel 74 of the economizer 58 via the feed line 59a. Water may be communicated from the first channel 74 to the heat exchanger 54 to remove heat energy from the water. Water may be communicated from the heat exchanger 54 to the ion exchange assembly 56. All, or a portion of, the water may be directed into the first and second flow paths 70a, 70b so that resin filters 72 may remove impurities from the water. All, or a portion of, the water entering the ion exchange assembly 56 may be communicated (e.g., diverted) to the third flow path 70c, which may bypass the resin filters 72. Purified water and/or bypass water may be communicated from the ion exchange assembly 56 to the second channel 76 of the economizer 58 to transfer heat energy from water in the first channel 74 to water in the second channel 76. Water from the second tank outlet 62 may be communicated to the electrochemical assembly 20 via the supply line 59c such that it may bypass the ion exchange assembly 56. Water from the second channel 76 of the economizer 58 may be communicated to the supply line 59c via the purification line 59b where it may combine with water from the second tank outlet 62. The flow may be combined at the junction 80. In the implementation of FIG. 3, purified water from the second channel 176 of the economizer 158 may be communicated to the second tank inlet 186 via the purification line 159b where it may combine with return water from the first tank inlet 164. The combined flow in the tank 152 may be communicated to the assembly 120 via the supply line 159c.

The controller 82 may execute the above methods by monitoring one or more operating conditions of the components of the system 50, 150 and may compare them to (e.g., preselected) criteria. The controller 82 may adjust operation of the components accordingly. The method may include maintaining a temperature of water at the anode inlet 31 and/or exchange inlet 66 at a respective (e.g., preselected) temperature threshold or range. In implementations, including electrolyzers, the temperature of the water at the anode inlet 31 may be between greater than or equal to approximately 60° C., or more narrowly between approximately 60° C. and approximately 80° C. A temperature of water at the exchange inlet 66 may be less than approximately 60° C. In other implementations, which may incorporate other electrochemical devices, the temperature at the anode inlet 31 may be greater than approximately 80° C. The controller 82 may maintain water temperatures by modulating the valves 61 and/or pumps 63.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

The preceding description is illustrative rather than limiting in nature. Variations and modifications to the disclosed examples may become apparent to those skilled in the art that do not necessarily depart from the essence of this invention.

What is claimed:

1. A system for electrolysis, comprising:
an electrochemical cell assembly having an anode inlet and an anode outlet;
a storage tank configured to hold a volume of water;
a supply line interconnecting the storage tank and the anode inlet;
a return line interconnecting the storage tank and the anode outlet;
an ion exchange assembly including an exchange inlet and an exchange outlet;
a heat exchanger interconnecting the storage tank and the exchange inlet; and
an economizer configured to transfer heat energy of water flowing through a first channel to water flowing through a second channel of the economizer, the first channel interconnecting the storage tank and an inlet of the heat exchanger, and the second channel configured to receive a flow of water from the exchange outlet.

2. The system of claim 1, wherein the storage tank comprises:
a tank inlet connected to the anode outlet via the return line;
a first tank outlet connected to the inlet of the economizer via a feed line; and
a second tank outlet connected to the anode inlet via the supply line.

3. The system of claim 2, further comprising a purification line that interconnects an outlet of the second channel of the economizer and a junction along the supply line.

4. The system of claim 2, further comprising a purification line that interconnects an outlet of the second channel of the economizer and a second tank inlet of the storage tank.

5. The system of claim 1, wherein the ion exchange assembly includes a plurality of ion exchange resin filters arranged in a plurality of flow paths between the exchange inlet and the exchange outlet.

6. The system of claim 5, wherein the plurality of flow paths include a first and second flow path, and the plurality of ion exchange resin filters includes first and second ion exchange resin filters arranged in series in the first flow path and third and fourth ion exchange resin filters arranged in series in the second flow path, and the first and second flow path are arranged in parallel.

7. The system of claim 6, wherein the plurality of flow paths of the ion exchange assembly further includes a third flow path arranged in parallel with the first and second flow paths, and the third flow path is a bypass line interconnecting the exchange inlet and the exchange outlet that is configured to selectively bypass the first and second flow paths.

8. The system of claim 1, wherein a junction along the supply line is adapted to combine a first flow from the supply tank and a second flow from an outlet of the second channel, and the supply line is adapted to communicate the combined flow to the anode inlet, and the second flow establishes approximately at least 10 percent of the combined flow.

9. The system of claim 1, further comprising:
a controller operable to modulate one or more valves and/or one or more pumps to vary a flow rate and/or a temperature of water flowing among the electrochemical cell assembly, storage tank, heat exchanger, ion exchange assembly, and economizer.

10. The system of claim 9, wherein the controller is operable to maintain a temperature of water at the anode inlet between approximately 60° C. and 80° C.

11. The system of claim 9, wherein the controller is configured to maintain a temperature of water at the exchange inlet below approximately 60° C.

12. A method for treating water for electrolysis comprising:
communicating water from an anode outlet of an electrochemical cell assembly via a return line to a storage tank;
communicating water from the storage tank to a first channel of an economizer via a feed line;
communicating water from the first channel of the economizer to a heat exchanger to remove heat energy from the water;
communicating water from the heat exchanger to an ion exchange assembly to remove impurities in the water;
communicating purified water from the ion exchange assembly to a second channel of the economizer to transfer heat energy from water in the first channel to the purified water in the second channel;
communicating the purified water from the second channel of the economizer to an anode inlet of the electrochemical cell assembly; and
communicating supply water from the storage tank to the anode inlet via a supply line such that the water bypasses the ion exchange assembly.

13. The method of claim 12, wherein the step of communicating the purified water from the second channel of the economizer to the anode inlet includes feeding the purified water from the second channel of the economizer to the storage tank through a second tank inlet via a purification line, such that the purified water and supply water combine in the storage tank to establish a combined flow which is communicated from the storage tank to the anode inlet via the supply line.

14. The method of claim 12, wherein the step of communicating the purified water from the second channel of the economizer to the anode inlet includes feeding the purified water from the second channel of the economizer to a junction along the supply line via a purification line such that the purified water and supply water combine to establish a combined flow to the anode inlet.

15. The method of claim 14, wherein the purified water is at least approximately 10 percent of the combined flow to the anode inlet but no more than approximately 70 percent of the combined flow to the anode inlet.

16. The method of claim 12, wherein the ion exchange assembly includes a plurality of ion exchange resin filters arranged in a plurality of flow paths between an exchange inlet and an exchange outlet.

17. The method of claim 16, wherein the plurality of ion exchange resin filters includes first and second ion exchange resin filters arranged in series in a first flow path and third and fourth ion exchange resin filters arranged in series in a second flow path, and the first and second flow path are arranged in parallel.

18. The method of claim 17, wherein the ion exchange assembly further includes a third flow path arranged in parallel with the first and second flow path, and the third flow path is configured to cause water to selectively bypass the first and second flow paths.

19. The method of claim 12, further comprising:
maintaining a temperature of water at the anode inlet to be between approximately 60° C. and 80° C.

20. The method of claim 12, further comprising:
maintaining a temperature of water at the exchange inlet to be less than approximately 60° C.
